(19) United States
(12) Patent Application Publication
(10) Pub. No.: US 2026/0302873 A1
(43) Pub. Date: Oct. 1, 2026

(54) ROTATING ELECTRIC MACHINE SYSTEM

(71) Applicant: HONDA MOTOR CO., LTD., Tokyo (JP)

(72) Inventors: Hideaki Sakai, Wako-shi (JP); Kosuke Nishiyama, Wako-shi (JP); Takeki Kishi, Wako-shi (JP); Hiroya Tsukui, Wako-shi (JP)

(21) Appl. No.: 19/630,823

(22) Filed: Mar. 27, 2026

(30) Foreign Application Priority Data
Mar. 31, 2025 (JP) 2025-058249

(51) Int. Cl. H02K 5/20; H02K 9/19; H02K 11/33; H02K 21/22

(52) U.S. Cl. CPC H02K 5/203; H02K 9/19; H02K 11/33; H02K 21/22

(57) ABSTRACT

Electrical components of a rotating electric machine system includes a plurality of capacitors and a plurality of power modules. A first principal surface of each of the capacitors and a second principal surface of each of the power modules are arranged to surround a rotating shaft part such that the normal directions of the first principal surface and the second principal surface are directed along a radial direction of the rotating shaft part. Each of the capacitors and each of the power modules are arranged such that the axial positions thereof at least partially overlap each other.

### CROSS-REFERENCE TO RELATED APPLICATIONS

This application is based upon and claims the benefit of priority from Japanese Patent Application No. 2025-058249 filed on Mar. 31, 2025, the contents of which are incorporated herein by reference.

### BACKGROUND OF THE INVENTION

### FIELD OF THE INVENTION

The present disclosure relates to a rotating electric machine system.

### DESCRIPTION OF THE RELATED ART

JP 7202979 B2 discloses a rotor of a rotating electric machine system. The rotating electric machine system is an outer rotor type rotating electric machine, and includes a rotor, a stator, and an inverter unit. The inverter unit includes a cylindrical inverter housing, and a plurality of capacitors and a plurality of power modules are annularly arranged inside the inverter housing. A space in which a rotating shaft of the rotor is accommodated is provided inside the plurality of capacitors and the plurality of power modules arranged annularly. The plurality of capacitors and the plurality of power modules are "placed flatly" and fixed on a plane perpendicular to an axial direction of a rotating shaft of the rotor inside the inverter housing such that principal surfaces of the circuit elements are parallel to the plane.

When the plurality of capacitors and the plurality of power modules are placed flatly, the area of the principal surface of each of the capacitors and each of the power modules is generally larger than the area of the side surface. Therefore, it is necessary to increase the area of the plane, and the size of the inverter housing in the radial direction increases. The increase in the size of the inverter housing causes a problem that the rotating electric machine system is increased in size in the radial direction of the rotating shaft.

JP 3559909 B2 discloses a rotating electric machine system. The rotating electric machine system includes a plurality of capacitors arranged in a circumferential direction, and a plurality of power modules arranged side by side in the circumferential direction. The plurality of capacitors and the plurality of power modules are arranged in an axial direction of the rotating electric machine. The plurality of capacitors and the plurality of power modules are arranged to be "placed vertically" on a circumferential portion around the rotating shaft such that normal directions of principal surfaces thereof are along a radial direction of the rotating shaft. When the plurality of capacitors and the plurality of power modules are placed vertically, an increase in the size of the rotating electric machine in the radial direction can be suppressed. However, there is a problem that the rotating electric machine system is increased in size in the axial direction of the rotating shaft by arranging the capacitors and the power modules so as not to overlap each other in the axial direction of the rotating shaft.

### SUMMARY OF THE INVENTION

The present invention has the object of solving the aforementioned problem.

A first aspect of the present disclosure is characterized by a rotating electric machine system equipped with a rotating electric machine including a rotor provided with a rotating shaft part, the rotating electric machine being configured to be driven by alternating current electrical power, and an electrical component configured to convert direct current electrical power into the alternating current electrical power, wherein the electrical component includes a plurality of capacitors and a plurality of power modules, the plurality of power modules and the plurality of capacitors each include a principal surface, and a side surface intersecting the principal surface and having an area smaller than an area of the principal surface, and wherein the capacitors and the power modules are arranged to surround the rotating shaft part in a manner so that normal directions of the principal surfaces are directed along a radial direction of the rotating shaft part, and the capacitors and the power modules are arranged in a manner so that in an axial direction of the rotating shaft part, an axial position of each of the capacitors and an axial position of each of the power modules at least partially overlap each other.

A second aspect of the present disclosure is characterized by a rotating electric machine system equipped with a rotating electric machine including a rotor provided with a rotating shaft part, the rotating electric machine being configured to be driven by alternating current electrical power, and an electrical component configured to convert direct current electrical power into the alternating current electrical power, wherein the electrical component includes a plurality of capacitors and a plurality of power modules, the plurality of power modules and the plurality of capacitors each have a radially projected area, an axially projected area, and a circumferentially projected area, and are each arranged in a manner so that the radially projected area is largest among the radially projected area, the axially projected area, and the circumferentially projected area, and the capacitors and the power modules are arranged so as to surround the rotating shaft part and are arranged in a manner so that in an axial direction of the rotating shaft part, an axial position of each of the capacitors and an axial position of each of the power modules at least partially overlap each other.

According to the present disclosure, by arranging the plurality of capacitors and the plurality of power modules so as to surround the rotating shaft part of the rotor, the capacitors and the power modules are arranged to be placed vertically along the axial direction, and the axial positions of the capacitors and the power modules are overlapped at least partially. Thus, the rotating electric machine system can be reduced in size in the radial direction without increasing the size of the rotating electric machine system in the axial direction. As a result, a compact rotating electric machine system can be provided. Further, even when the space is provided inside the rotating electric machine system, an increase in the size of the rotating electric machine system in the radial direction and the axial direction is effectively suppressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall cross-sectional view of a rotating electric machine system according to an embodiment of the present disclosure;

FIG. 2 is a plan view illustrating a cooling structure of the rotating electric machine;

FIG. 3 is a cross-sectional view taken along line III-III of FIG. 1;

FIG. 4 is a perspective cross-sectional view of the rotating electric machine illustrated in FIG. 1.

FIG. 5 is an enlarged cross-sectional view illustrating a heat insulating structure of the rotating electric machine;

FIG. 6 is a configuration diagram illustrating a cooling system of the rotating electric machine system; and

FIG. 7 is a plan view of a rotating electric machine according to an exemplary modification.

### DETAILED DESCRIPTION OF THE INVENTION

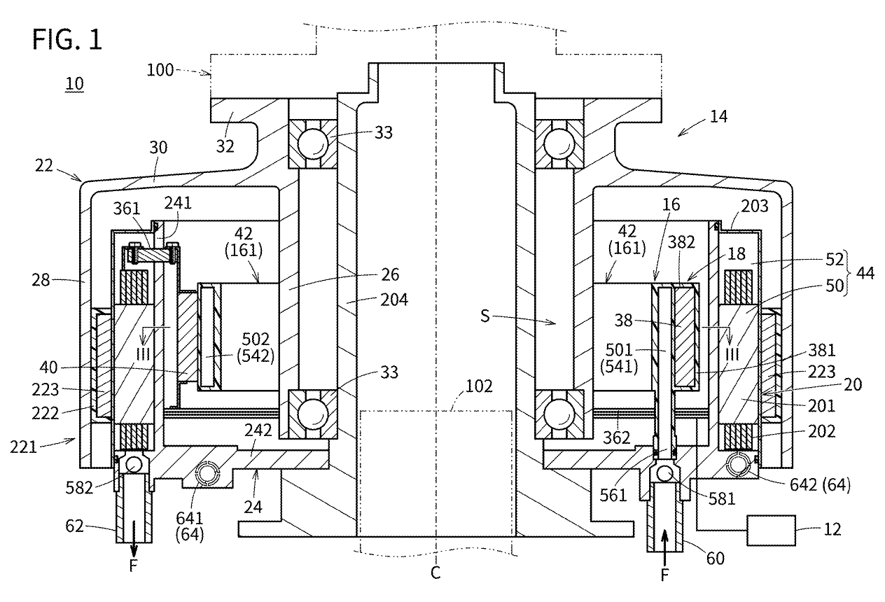

As shown in FIG. 1, a rotating electric machine system 10 according to the present embodiment is used, for example, as a power source of a moving object. Examples of the moving object on which the rotating electric machine system 10 is mounted, for example, include an electric vertical take-off and landing aircraft (also referred to as an eVTOL aircraft) (not shown). Hereinafter, a description will be given concerning a case in which the rotating electric machine system 10 is used as a power source of an electric vertical take-off and landing aircraft.

The rotating electric machine system 10 includes a DC power source 12, a rotating electric machine 14, electrical components 16, and a cooling structure 18. The DC power source 12 is, for example, a battery. The DC power source 12 supplies electric power to a coil 202 of the rotating electric machine 14 via the electrical components 16.

The rotating electric machine 14 is an electric motor driven by AC electrical power. The rotating electric machine 14 is, for example, a polyphase AC motor (for example, a three-phase AC motor).

The rotating electric machine 14 includes a stator 20, a rotor 22, and a case member 24. The rotating electric machine 14 is an outer rotor type rotating electric machine 14 in which at least a part of the rotor 22 is disposed radially outward of the stator 20.

The stator 20 includes a stator core 201, the coils 202 of respective phases, and a stator cover 203. The stator core 201 has a substantially cylindrical shape along the axial direction. The stator core 201 includes a plurality of teeth extending in the radial direction. Each of the coils 202 is provided between the teeth. The stator cover 203 covers the outside of the stator core 201.

The rotor 22 includes a rotor shaft 221, a rotor core 222, and a plurality of magnets 223. The rotor shaft 221 includes an inner cylinder portion 26, an outer cylinder portion 28, a connecting portion 30, and a rotor retaining portion 32. Each of the inner cylinder portion 26 and the outer cylinder portion 28 has a substantially cylindrical shape along an axis C of the rotor 22. The inner cylinder portion 26 is disposed radially inward of the outer cylinder portion 28. The inner cylinder portion 26 is rotatably supported by an inner circumferential portion 204 of the stator 20 by a pair of bearings 33. The outer cylinder portion 28 is disposed outside of the inner cylinder portion 26 in the radial direction. The connecting portion 30 connects the inner cylinder portion 26 and the outer cylinder portion 28 in the radial direction. The rotor retaining portion 32 protrudes upward from the connecting portion 30. For example, a propeller rotor 100 of an electric vertical take-off and landing aircraft is attached to an upper portion of the rotor retaining portion 32.

The rotor core 222 having a substantially cylindrical shape is attached to the inner circumference of the outer cylinder portion 28. The plurality of magnets 223 are attached to the inner circumference of the rotor core 222. The outer cylinder portion 28 retains the rotor core 222 and the plurality of magnets 223. The plurality of magnets 223 are arranged so as to surround the outer circumferential portion of the stator 20.

The case member 24 includes a stator retaining portion 241 and a cover portion 242. The stator retaining portion 241 is formed in a cylindrical shape and retains the stator 20. The stator retaining portion 241 is arranged radially inward of the stator 20. The stator retaining portion 241 extends in the axial direction of the rotating electric machine 14. The stator retaining portion 241 is provided between the stator 20 and the electrical components 16.

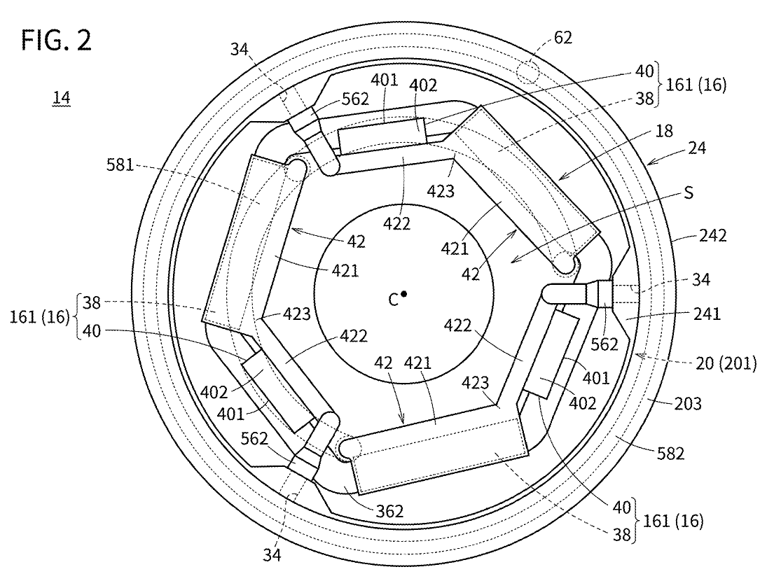

As shown in FIG. 2, the stator retaining portion 241 includes a plurality of hole portions 34. The plurality of hole portions 34 penetrate the stator retaining portion 241 in the radial direction and are spaced apart from each other in the circumferential direction of the stator retaining portion 241. Hereinafter, a description will be given concerning a case in which three hole portions 34 are provided. The number of hole portions 34 is not limited to three. The number of hole portions 34 may be less than or equal to two, or may be greater than or equal to four. The plurality of hole portions 34 are provided in the vicinity of the upper end part of the stator retaining portion 241.

The cover portion 242 is formed in a substantially disc shape and is provided at an axial end part of the stator retaining portion 241. As shown in FIG. 1, the cover portion 242 extends in the radial direction from a lower end part of the stator retaining portion 241. The cover portion 242 faces the electrical components 16 in the axial direction of the rotating electric machine 14. The cover portion 242 covers the lower end part of the electrical components 16. A central part of the cover portion 242 is fixed to the inner circumferential portion 204 of the stator 20.

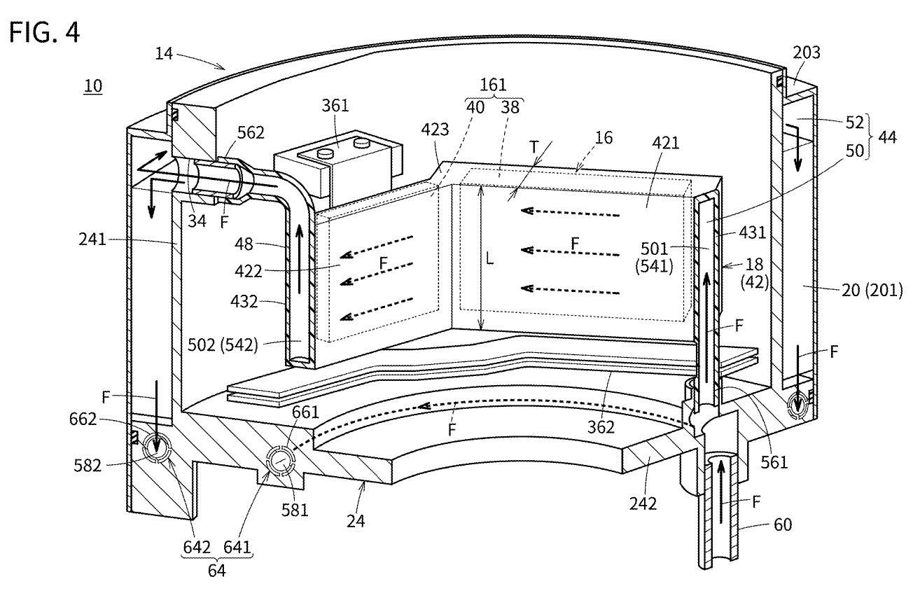

The rotating electric machine 14 further includes a plurality of first bus bars 361 and a second bus bar 362. The electrical components 16 include the plurality of first bus bars 361 and the second bus bar 362. Each of the plurality of first bus bars 361 electrically connects the coil 202 of each phase in the stator 20 and the electrical components 16. Each of the first bus bars 361 is provided at one end part (an upper end part) of the electrical components 16 in the axial direction. The first bus bars 361 are electrically connected to a plurality of power modules 40 (see FIG. 4), respectively.

The second bus bar 362 electrically connects the DC power source 12 and the electrical components 16. The second bus bar 362 is provided at the other end part (a lower end part) of the electrical components 16 in the axial direction. The second bus bar 362 is electrically connected to each of a plurality of capacitors 38 and each of the plurality of power modules 40. The first bus bars 361 and the second bus bar 362 are disposed apart from each other in the axial direction of the rotating electric machine 14.

The electrical components 16 convert DC electrical power supplied from the DC power source 12 into AC electrical power and supplies the AC electrical power to the coils 202 of the rotating electric machine 14. Specifically, the DC power source 12 supplies electrical power to the coils 202 of the rotating electric machine 14 via the second bus bar 362, the electrical components 16, and the first bus bars 361. The rotor 22 rotates relative to the stator 20 by periodically energizing the coils 202 of the respective phases.

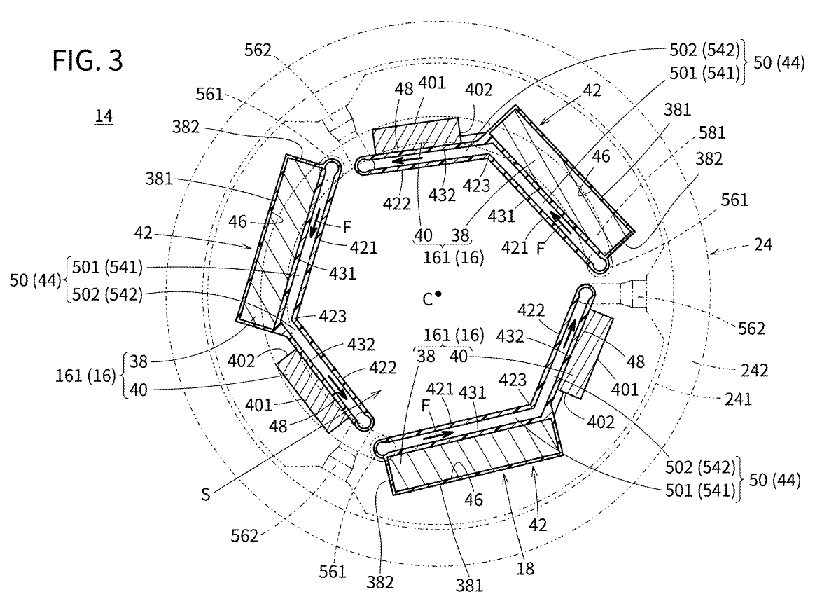

As shown in FIG. 3, the electrical components 16 include a plurality of conversion units 161. The plurality of conversion units 161 are provided radially inward of the stator retaining portion 241 of the case member 24 (see FIG. 1). The plurality of conversion units 161 are arranged in the circumferential direction along the stator retaining portion 241 of the rotating electric machine 14. The plurality of conversion units 161 are disposed so as to surround the axis C of the rotor 22 (see FIG. 1). The plurality of conversion units 161 are disposed radially outward with respect to the axis C of the rotor 22. The plurality of conversion units 161 are disposed radially inward of the stator 20. Hereinafter, a description will be given concerning a case in which three of the conversion units 161 are provided.

Each of the plurality of conversion units 161 includes the capacitor 38 and the power module 40. That is, the plurality of (three in each) capacitors 38 and power modules 40 are provided. Hereinafter, a description will be given concerning a case in which the three power modules 40 and the three capacitors 38 are provided. The number of capacitors 38 and the number of power modules 40 are not limited to three. For example, the number of capacitors 38 and power modules 40 may be two, or four or more. Also, the number of power modules 40 and the number of capacitors 38 are not limited to the same number. For example, the number of capacitors 38 may be any integral multiple of the number of power modules 40. The number of capacitors 38 need not necessarily be any integral multiple of the number of power modules 40.

The capacitor 38 smooths the AC electrical power converted by the power module 40. The capacitor 38 is disposed side by side with the power module 40 in the circumferential direction of the rotating electric machine 14. The capacitor 38 includes a first principal surface 381 and a first side surface 382. The first principal surface 381 faces in the thickness direction of the capacitor 38. The first principal surface 381 is largest surface of the capacitor 38. The first principal surface 381 faces in the radial direction of the rotating electric machine 14. That is, the normal direction of the first principal surface 381 is directed in the radial direction. The first side surface 382 is perpendicular to the first principal surface 381. The first side surface 382 is a surface along the thickness direction of the capacitor 38. The area of the first side surface 382 is smaller than the area of the first principal surface 381. That is, the area of the first principal surface 381 is larger than the area of the first side surface 382.

The capacitor 38 further has a first radially projected area, a first axially projected area, and a first circumferentially projected area. The first radially projected area is an area of the capacitor 38 when projected in the radial direction of the rotating electric machine 14. The first axially projected area is an area of the capacitor 38 when the projected in the axial direction of a rotating shaft part of the rotor 22. The first circumferentially projected area is an area of the capacitor 38 when projected in the circumferential direction of the rotating electric machine 14.

The capacitor 38 is arranged such that the first radially projected area is largest among the first radially projected area, the first axially projected area, and the first circumferentially projected area. That is, the capacitor 38 is disposed to be placed vertically along the axial direction of the rotating shaft part of the rotor 22.

The power module 40 converts DC electrical power into AC electrical power. The power module 40 is arranged side by side with the capacitor 38 in the circumferential direction of the rotating electric machine 14. The power module 40 includes a second principal surface 401 and a second side surface 402. The second principal surface 401 is a surface facing the thickness direction of the power module 40, and the second principal surface 401 is largest surface in the power module 40. The second principal surface 401 faces in the radial direction of the rotating electric machine 14. That is, the normal direction of the second principal surface 401 is directed in the radial direction. The second side surface 402 is perpendicular to the second principal surface 401. The second side surface 402 is a surface along the thickness direction of the power module 40. The second side surface 402 is perpendicular to the second principal surface 401. The area of the second side surface 402 is smaller than the area of the second principal surface 401. That is, the area of the second principal surface 401 is larger than the area of the second side surface 402.

The power module 40 further has a second radially projected area, a second axially projected area, and a second circumferentially projected area. The second radially projected area is an area of the power module 40 when projected in the radial direction of the rotating electric machine 14. The second axially projected area is an area of the power module 40 when the projected in the axial direction of the rotating shaft part of the rotor 22. The second circumferentially projected area is an area of the power module 40 when projected in the circumferential of the rotating electric machine 14.

The power module 40 is arranged such that the second radially projected area is largest among the second radially projected area, the second axially projected area, and the second circumferentially projected area. That is, the power module 40 is disposed to be placed vertically along the axial direction of the rotating shaft part of the rotor 22.

In each of the conversion units 161, the capacitor 38 and the power module 40 are arranged such that in the axial direction of the rotating shaft part of the rotor 22, the axial position of the capacitor 38 and the axial position of the power module 40 at least partially overlap each other. Hereinafter, a description will be given concerning a case in which the axial position of the capacitor 38 and the axial position of the power module 40 are the same position and the axial positions completely overlap each other. The axial position of the capacitor 38 and the axial position of the power module 40 may be shifted from each other in the axial direction of the rotating shaft part.

Each of the plurality of conversion units 161 is arranged such that the normal direction of the first principal surface 381 of the capacitor 38 is directed in the radial direction and the normal direction of the second principal surface 401 of the power module 40 is directed in the radial direction.

As shown in FIG. 1, the electrical components 16 and the stator 20 are arranged apart from each other in the radial direction of the rotating electric machine 14. The stator retaining portion 241 is provided between the plurality of conversion units 161 and the stator 20 in the radial direction of the rotating electric machine 14. The electrical components 16 and the stator 20 are arranged in parallel with each other in the radial direction.

The cooling structure 18 cools the plurality of conversion units 161 and the rotating electric machine 14.

As shown in FIG. 3, the cooling structure 18 includes a plurality of cooling jackets 42 and a cooling medium flow portion 44. The plurality of cooling jackets 42 cool the plurality of conversion units 161, respectively. Each of the cooling jackets 42 cools the capacitor 38 and the power module 40 of each of the conversion units 161. The number of cooling jackets 42 is the same as the number of conversion units 161. Hereinafter, a description will be given concerning a case in which three of the cooling jackets 42 are provided. The three cooling jackets 42 are provided for the three phases, respectively.

The cooling structure 18 may be configured such that the plurality of cooling jackets 42 are independently provided and arranged apart from each other, or may be configured such that one jacket portion is provided so as to include the plurality of cooling jackets 42 as an integrated structure. That is, it is adequate that the plurality of cooling jackets 42 and the conversion units 161 of the respective phases may be provided to correspond to each other.

The number of capacitors 38 and the number of power modules 40 in each of the cooling jackets 42 are the same. Hereinafter, a description will be given concerning a case in which each of the cooling jackets 42 includes one capacitor 38 and one power module 40. Each of the cooling jackets 42 may include two or more capacitors 38 and two or more power modules 40. Further, the number of capacitors 38 and the number of power modules 40 in each of the cooling jackets 42 may be different from each other.

As shown in FIG. 2, the plurality of cooling jackets 42 are arranged in the circumferential direction of the rotating electric machine 14. The plurality of conversion units 161 are disposed so as to surround the axis C of the rotor 22. The plurality of cooling jackets 42 are spaced apart from each other in the circumferential direction of the rotating electric machine 14. The plurality of cooling jackets 42 are disposed radially inward of the stator retaining portion 241 in the case member 24.

Each of the cooling jackets 42 includes a first attachment portion 421 and a second attachment portion 422. The capacitor 38 is attached to the first attachment portion 421. As shown in FIG. 3, the first attachment portion 421 has an accommodation chamber 46 in which the capacitor 38 is accommodated. The capacitor 38 is accommodated in the accommodation chamber 46 from an opening end part (not shown) of the first attachment portion 421 that is open in the axial direction. The capacitor 38 is accommodated such that the first principal surface 381 faces in the radial direction of the rotating electric machine 14.

The power module 40 is attached to the second attachment portion 422. The second attachment portion 422 is adjacent to the first attachment portion 421 in the circumferential direction of the rotating electric machine 14. The second attachment portion 422 has an attachment surface 48 facing radially outward. The power module 40 is attached to the attachment surface 48. The first attachment portion 421 and the second attachment portion 422 are coupled to each other by a coupling portion 423 in the circumferential direction of the rotating electric machine 14. In a plan view of the rotating electric machine 14, the first attachment portion 421 and the second attachment portion 422 are inclined with respect to each other with the coupling portion 423 as a fulcrum. For example, the second attachment portion 422 is inclined within a range of 90 to 180 degrees with respect to the first attachment portion 421.

As shown in FIG. 4, each of the cooling jackets 42 has a thickness T along the radial direction and a length L along the axial direction of the rotor 22, and the thickness T is smaller than the length L. The thickness direction of each of the cooling jackets 42 is the normal direction of the first principal surface 381 of the capacitor 38 and the normal direction of the second principal surface 401 of the power module 40 (see FIG. 3). The length direction of each of the cooling jackets 42 is the extending direction of the first principal surface 381 and the second principal surface 401 along the axial direction of the rotor 22.

As shown in FIG. 2, in a plan view of the rotating electric machine 14, the plurality of cooling jackets 42 are arranged in a substantially annular shape by arranging the plurality of cooling jackets 42 each having the first attachment portion 421 and the second attachment portion 422 that are inclined with respect to each other. The plurality of conversion units 161 (the plurality of capacitors 38 and the plurality of power modules 40) are arranged between the plurality of cooling jackets 42 and the stator 20. A space S is provided radially inward of the plurality of conversion units 161. As shown in FIG. 1, the space S extends in the axial direction of the rotating electric machine 14. In a plan view of the rotating electric machine 14, the space S has a substantially circular shape. The space S can accommodate an auxiliary device 102 for controlling the electric vertical take-off and landing aircraft or the like, the inner cylinder portion 26 of the rotor shaft 221, the bearings 33, and the like.

The present disclosure is not limited to the configuration in which the plurality of conversion units 161 are provided between the plurality of cooling jackets 42 and the stator 20. For example, the plurality of cooling jackets 42 may be provided between the plurality of conversion units 161 and the stator 20. In this case, the conversion units 161 can be disposed radially inward, further away from the stator 20 having a large heat generation amount.

As shown in FIG. 4, the cooling medium F flows through the cooling medium flow portion 44. The cooling medium F is, for example, a lubricating oil. The cooling medium flow portion 44 includes a jacket flow path 50 and a stator cooling flow path 52. The cooling medium F is not limited to the lubricating oil. For example, the cooling medium F may be a liquid such as water.

The jacket flow path 50 is provided in each of the plurality of cooling jackets 42. Each of the jacket flow paths 50 includes a first flow portion 501 and a second flow portion 502.

The first flow portion 501 cools the capacitor 38. The first flow portion 501 is provided in the first attachment portion 421. The first flow portion 501 includes a first jacket flow path 541 through which the cooling medium F flows. The first jacket flow path 541 extends in a widthwise direction of the first attachment portion 421 perpendicular to a thickness direction of the first attachment portion 421 and the axial direction of the rotor 22. The first jacket flow path 541 is disposed radially inward of the capacitor 38 across a wall portion 431 of the first attachment portion 421 (see FIG. 3).

The second flow portion 502 cools the power module 40. The second flow portion 502 is provided in the second attachment portion 422. The second flow portion 502 includes a second jacket flow path 542 through which the cooling medium F flows. The second jacket flow path 542 extends in the widthwise direction of the second attachment portion 422 perpendicular to the thickness direction of the second attachment portion 422 and the axial direction of the rotor 22.

The second jacket flow path 542 is disposed radially inward of the power module 40 across a wall portion 432 of the second attachment portion 422. The first jacket flow path 541 and the second jacket flow path 542 are connected to each other and communicate with each other at the coupling portion 423 of each of the cooling jackets 42 (see FIG. 3). In the flow direction of the cooling medium F, the second jacket flow path 542 (second flow portion 502) is connected to the first jacket flow path 541 downstream of the first jacket flow path 541 (first flow portion 501).

The jacket flow path 50 further includes a first connecting portion 561 and a second connecting portion 562. The first connecting portion 561 is formed at an end part of the first jacket flow path 541. The first connecting portion 561 is an upstream end of the first jacket flow path 541 into which the cooling medium F is introduced. The first connecting portion 561 is provided at the axially lower end of the first attachment portion 421. The first connecting portion 561 faces the cover portion 242 of the case member 24.

The second connecting portion 562 is formed at an end part of the second jacket flow path 542. The second connecting portion 562 is a downstream end of the second jacket flow path 542 from which the cooling medium F is led out. The second connecting portion 562 is provided on the radially outer surface of the second attachment portion 422. The second connecting portion 562 is connected to each of the hole portions 34 of the stator retaining portion 241.

The cooling medium F for cooling the rotating electric machine 14 flows through the stator cooling flow path 52. The stator cooling flow path 52 is surrounded by the stator retaining portion 241, the stator cover 203, and the cover portion 242 of the case member 24. The stator cooling flow path 52 is a space in which the stator 20 is accommodated. The stator cooling flow path 52 is formed in an annular shape. The stator cooling flow path 52 communicates with the second connecting portion 562 through each of the hole portions 34 of the stator retaining portion 241. The cooling medium F flowing through each of the plurality of second jacket flow paths 542 flows to the stator cooling flow path 52 through each of the second connecting portions 562, thereby cooling the stator 20. That is, the cooling medium F flowing through the plurality of second jacket flow paths 542 is collected in one stator cooling flow path 52.

As shown in FIG. 1, the cooling medium flow portion 44 further includes a first flow path 581, a second flow path 582, an inlet portion 60, an outlet portion 62, and a heat insulating structure 64. The first flow path 581, the second flow path 582, the inlet portion 60, and the outlet portion 62 are provided in the cover portion 242 of the case member 24.

The first flow path 581 is connected to the first jacket flow path 541 of each of the cooling jackets 42. The first flow path 581 is connected to the upstream part of each of the first jacket flow paths 541. As illustrated in FIG. 3, in a plan view of the cover portion 242, the first flow path 581 is formed in an arc shape along the outer edge portion of the cover portion 242. The first flow path 581 is connected to each of the first connecting portions 561 of the plurality of first jacket flow paths 541 and communicates with each other. That is, the plurality of first jacket flow paths 541 are connected in parallel to the single first flow path 581. The cooling medium F flowing through the first flow path 581 is supplied to each of the first jacket flow paths 541 substantially simultaneously.

As shown in FIG. 1, the second flow path 582 is connected to and communicates with the stator cooling flow path 52. The second flow path 582 is connected to the downstream part of the stator cooling flow path 52. As illustrated in FIG. 2, in a plan view of the cover portion 242, the second flow path 582 is formed in an arc shape along the outer edge portion of the cover portion 242. The first flow path 581 and the second flow path 582 are arranged to be separated from each other in the radial direction of the cover portion 242. In the cover portion 242, the second flow path 582 is disposed radially outward of the first flow path 581. The cooling medium F flowing through the stator cooling flow path 52 is led out to the second flow path 582.

As shown in FIG. 1, the inlet portion 60 communicates with the first flow path 581 and the first flow portion 501, and the cooling medium F is introduced from the outside. The inlet portion 60 extends in the axial direction of the cover portion 242. The inlet portion 60 is connected to an upstream end of the first flow path 581. The inlet portion 60 protrudes in the axial direction from an end part of the cover portion 242. A supply piping 761 described later is connected to the inlet portion 60.

The outlet portion 62 communicates with the second flow path 582 and the second flow portion 502 to lead the cooling medium F to the outside. The outlet portion 62 is connected to the stator cooling flow path 52 and the downstream part of each of the cooling jackets 42. The outlet portion 62 extends in the axial direction of the cover portion 242. The outlet portion 62 is connected to the downstream end of the second flow path 582. The outlet portion 62 protrudes in the axial direction from an end part of the cover portion 242. A discharge piping 762 described later is connected to the outlet portion 62, and the cooling medium F flowing through the cooling medium flow portion 44 is discharged.

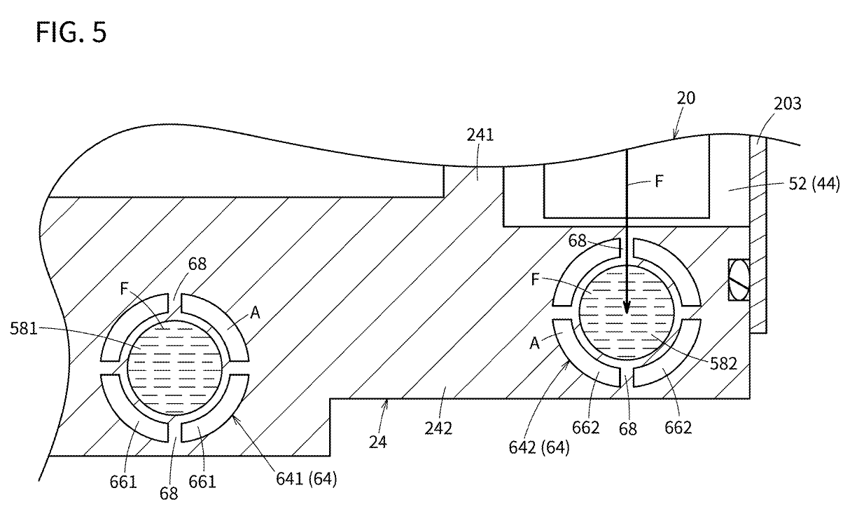

As shown in FIG. 5, the heat insulating structure 64 includes a first heat insulating portion 641 and a second heat insulating portion 642. The first heat insulating portion 641 is provided for heat insulation between the cooling medium F flowing through the first flow path 581 and the cover portion 242. The first heat insulating portion 641 is provided on the outer circumferential part of the first flow path 581. The first heat insulating portion 641 covers the outer circumferential part of the first flow path 581. The first heat insulating portion 641 extends along the first flow path 581. The first heat insulating portion 641 has a first heat insulating space 661. The first heat insulating space 661 is filled with a heat insulating medium A.

The first flow path 581 is supported by the cover portion 242 across the first heat insulating space 661 by a supporting portion 68 extending radially outward. The heat insulating medium A is a gas such as air. The heat insulating medium A is not limited to a gas. For example, the heat insulating medium A may be a liquid. The heat insulating medium A in the first heat insulating space 661 suppresses heat exchange between the cooling medium F flowing through the first flow path 581 and the cover portion 242.

The second heat insulating portion 642 is provided for heat insulation between the cooling medium F flowing through the second flow path 582 and the cover portion 242. The second heat insulating portion 642 is provided on the outer circumferential part of the second flow path 582. The second heat insulating portion 642 covers the outer circumferential part of the second flow path 582. The second heat insulating portion 642 extends along the second flow path 582. The second heat insulating portion 642 has a second heat insulating space 662. The second heat insulating space 662 is filled with the heat insulating medium A. The heat insulating medium A in the second heat insulating space 662 is the same as the heat insulating medium A in the first heat insulating space 661. The heat insulating medium A in the second heat insulating space 662 may be different from the heat insulating medium A in the first heat insulating space 661.

The second flow path 582 is supported by the cover portion 242 across the second heat insulating space 662 by the supporting portion 68 extending radially outward. The heat insulating medium A in the second heat insulating space 662 suppresses heat exchange between the cooling medium F flowing through the second flow path 582 and the cover portion 242. The first heat insulating portion 641 and the second heat insulating portion 642 suppress heat transfer between the cooling medium F flowing through the first flow path 581 and the cooling medium F flowing through the second flow path 582.

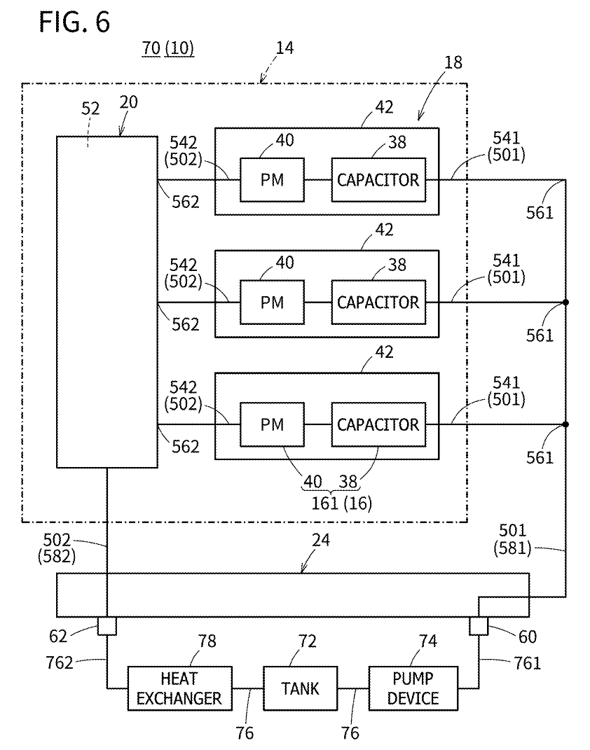

As shown in FIG. 6, the rotating electric machine system 10 further includes a cooling system 70. The cooling system 70 circulates the cooling medium F in the cooling structure 18. The cooling system 70 is equipped with a tank 72, a pump device 74, a piping 76, and a heat exchanger 78. The cooling system 70 is provided, for example, below the rotating electric machine 14. The tank 72 stores the cooling medium F. The pump device 74 is driven by supply of electrical power from the DC power source 12 (see FIG. 1). The pump device 74 is driven to supply the cooling medium F in the tank 72 toward the cooling structure 18 through the piping 76.

The piping 76 is equipped with the supply piping 761 and the discharge piping 762. The supply piping 761 is connected to a downstream side of the pump device 74. The supply piping 761 is a piping for supplying the cooling medium F stored in the tank 72 to the cooling structure 18. The supply piping 761 is connected to the inlet portion 60 of the cooling structure 18. The discharge piping 762 is a piping for returning the cooling medium F used for cooling in the cooling structure 18 to the tank 72. The discharge piping 762 is connected to the outlet portion 62 of the cooling structure 18.

The heat exchanger 78 is disposed between the tank 72 and the cooling structure 18. The heat exchanger 78 is, for example, a radiator. The heat exchanger 78 is connected to the supply piping 761 and the discharge piping 762. The cooling medium F heated by the cooling structure 18 is introduced into the heat exchanger 78 through the discharge piping 762. The heat exchanger 78 radiates heat from the heated cooling medium F and then supplies the cooling medium F to the cooling structure 18 via the supply piping 761.

A description will be given concerning the cooling of the rotating electric machine system 10.

When the pump device 74 is driven, the cooling medium F in the tank 72 is sucked through the piping 76 and supplied to the inlet portion 60 of the rotating electric machine 14 through the heat exchanger 78. As shown in FIG. 4, the cooling medium F is supplied from the inlet portions 60 to the plurality of cooling jackets 42 through the first flow path 581, whereby the cooling medium F cools the plurality of conversion units 161 (the capacitors 38 and the power modules 40). Specifically, the cooling medium F is supplied to each of the first jacket flow paths 541 of the plurality of cooling jackets 42. At this time, the cooling medium F is supplied to each of the three cooling jackets 42 substantially at the same time (see FIG. 6). The capacitor 38 of each of the conversion units 161 is cooled by the cooling medium F flowing through each of the first jacket flow paths 541. Specifically, as shown in FIG. 3, heat exchange is performed between the cooling medium F and the capacitor 38 via the first attachment portion 421. The capacitor 38 is cooled, while the cooling medium F is heated.

The cooling medium F flows from each of the first jacket flow paths 541 to each of the second jacket flow paths 542. The power module 40 of each of the conversion units 161 is cooled by the cooling medium F flowing through each of the second jacket flow paths 542. Specifically, heat exchange is performed between the cooling medium F and the power module 40 via the second attachment portion 422. The power module 40 is cooled, while the cooling medium F is heated.

Next, the stator 20 of the rotating electric machine 14 is cooled by the cooling medium F. Specifically, as shown in FIG. 4, the cooling medium F flows from each of the second jacket flow paths 542 to the stator cooling flow path 52 through each of the second connecting portions 562. The cooling medium F in each of the cooling jackets 42 is collected in the stator cooling flow path 52 through each of the second connecting portions 562 (see FIG. 6). At this time, the cooling medium F is supplied to the stator cooling flow path 52 uniformly in the circumferential direction of the stator cooling flow path 52 through the plurality of hole portions 34 separated from each other in the circumferential direction (see FIG. 3).

In the stator cooling flow path 52, the cooling medium F flows toward the lower part of the stator 20. When the cooling medium F comes into contact with the stator 20, heat exchange between the cooling medium F and the stator 20 is performed, and the stator 20 is cooled. The cooling medium F flows from the lower part of the stator cooling flow path 52 to the second flow path 582, and is discharged from the second flow path 582 to the outside through the outlet portions 62.

As shown in FIG. 6, the cooling medium F flows from the outlet portions 62 into the heat exchanger 78 through the discharge piping 762, and the heat of the cooling medium F is radiated in the heat exchanger 78. After the heat is radiated in the heat exchanger 78, the cooling medium F circulates to the cooling structure 18 of the rotating electric machine 14 through the supply piping 761.

According to the present embodiment, the following advantageous effects are obtained.

As shown in FIG. 3, the rotating electric machine system 10 includes the electrical components 16 that convert DC electrical power into AC electrical power, and the electrical components 16 include the plurality of capacitors 38 and the plurality of power modules 40. Each of the capacitors 38 and each of the power modules 40 are arranged in the circumferential direction such that the normal direction of the first principal surface 381 of each of the capacitors 38 and the normal direction of the second principal surface 401 of each of the power modules 40 are directed in the radial direction, and the capacitors 38 and the power modules 40 surround the axis C of the rotor shaft 221 of the rotor 22. The capacitor 38 and the power module 40 are arranged such that the axial position of the capacitor 38 and the axial position of the power module 40 at least partially overlap each other.

According to the rotating electric machine system 10, by arranging the plurality of capacitors 38 and the plurality of power modules 40 so as to surround the rotating shaft part of the rotor 22, the capacitors 38 and the power modules 40 are arranged to be placed vertically along the axial direction of the rotating shaft part, and the axial positions of the capacitors 38 and the power modules 40 are overlapped at least partially. Thus, the rotating electric machine system 10 can be reduced in size in the radial direction without increasing the size of the rotating electric machine system 10 in the axial direction.

As a result, the entire rotating electric machine system 10 can be made compact. By suppressing an increase in the size of the rotating electric machine 14 in the axial direction, the strength in the axial direction can be effectively ensured. Further, even when the space S is provided inside the rotating electric machine system 10, an increase in the size of the rotating electric machine system 10 in the radial direction and the axial direction is effectively suppressed.

As shown in FIG. 4, in the conversion unit 161, the capacitor 38 and the power module 40 are arranged in the circumferential direction. In accordance with such a configuration, it is possible to more effectively suppress an increase in the size of the rotating electric machine system 10 in the axial direction.

As shown in FIG. 4, the plurality of cooling jackets 42 for respectively cooling the plurality of conversion units 161 are provided. Each of the plurality of cooling jackets 42 has the first jacket flow path 541 and the second jacket flow path 542 through which the cooling medium F flows. In each of the plurality of cooling jackets 42, the thickness T along the normal direction of the first principal surface 381 of the capacitor 38 and the normal direction of the second principal surface 401 of the power module 40 is smaller than the length L along the axial direction of the rotor 22.

In accordance with such a configuration, in addition to the conversion unit 161, the cooling jacket 42 is disposed to be placed vertically along the axial direction, so that an increase in the size of the rotating electric machine system 10 in the radial direction is effectively suppressed. The cooling efficiency can be enhanced by increasing the contact area between the cooling jacket 42 and both the capacitor 38 and the power module 40 in the axial direction of the rotating electric machine 14.

As shown in FIG. 3, the plurality of cooling jackets 42 are provided for the three phases (multiple phases), respectively.

In accordance with such a configuration, since the plurality of cooling jackets 42 are respectively provided for the three phases (multiple phases), the capacitors 38 and the power modules 40 can be cooled in the respective phases. Therefore, the conversion units 161 in the respective phases can be uniformly cooled. In addition, it is possible to effectively suppress the cooling variation among the three phases.

Each of the plurality of cooling jackets 42 includes one condenser 38 and one power module 40. The jacket flow path 50 of the cooling medium flow portion 44 includes the first flow portion 501 for cooling the capacitor 38 and the second flow portion 502 for cooling the power module 40.

In accordance with such a configuration, the cooling efficiency in the conversion unit 161 can be effectively increased by cooling the capacitor 38 having a small heat generation amount with the cooling medium F before the power module 40, and the cooling of the capacitor 38 and the power module 40 can be uniformly maintained. Further, a degree of cooling in each of the plurality of cooling jackets 42 can be kept uniform.

The capacitors 38 and the power modules 40 are alternately arranged along the circumferential direction of the rotating electric machine 14. In accordance with such a configuration, the amount of heat generation in the circumferential direction of the rotating electric machine 14 can be made uniform.

The plurality of cooling jackets 42 are spaced apart from each other in the circumferential direction. In accordance with such a configuration, by separating the cooling jackets 42 from each other, the thermal influence of the adjacent cooling jackets 42 can be effectively suppressed. The spaces between the plurality of cooling jackets 42 can be effectively utilized.

As shown in FIG. 2, the stator 20 and the electrical components 16 are arranged in parallel with each other and spaced apart from each other in the radial direction. In accordance with such a configuration, the stator 20 and the electrical components 16 are arranged in the radial direction, and thus the rotating electric machine system 10 can be reduced in size in the axial direction. The heat generated in the stator 20 can be effectively prevented from being transmitted to the electrical components 16.

As shown in FIG. 2, the case member 24 has a plurality of hole portions 34 that penetrate the case member 24 in the radial direction and are spaced apart from each other in the circumferential direction. The jacket flow path 50 includes the first connecting portion 561 provided at the upstream end portion and the second connecting portion 562 provided at the downstream end portion and connected to each of the hole portions 34. The cooling medium F flowing through the plurality of jacket flow paths 50 flows toward the stator 20 through the hole portions 34.

In accordance with such a configuration, the cooling circuit of the electrical components 16 and the cooling circuit of the stator 20 are connected in series via the cooling jackets 42, and thus the cooling paths of the electrical components 16 and the cooling path of the stator 20 can be effectively separated from each other. Therefore, the plurality of electrical components 16 can be uniformly cooled, and the cooling efficiency can be further enhanced. Further, the stator 20 is uniformly cooled in the circumferential direction by the plurality of hole portions 34, and thus cooling efficiency can be enhanced. Further, the cooling jackets 42 and the stator retaining portion 241 are connected to each other in the radial direction, so that the size in the radial direction can be reduced.

As shown in FIG. 1, the case member 24 includes the cover portion 242 that faces the electrical components 16 in the axial direction. The cover portion 242 includes the first flow path 581 that is connected to the upstream end portion and through which the cooling medium F flows, and the inlet portion 60 that communicates with the first flow path 581 and the first jacket flow paths 541 and into which the cooling medium F is introduced.

According in accordance with such a configuration, since the cover portion 242 for supplying the cooling medium F from the outside to the cooling jackets 42 does not overlap the electrical components 16 in the radial direction, the rotating electric machine system 10 can be further reduced in size in the radial direction.

As shown in FIG. 5, the first flow path 581 and the second flow path 582 respectively have the first heat insulating space 661 and the second heat insulating space 662 that are filled with the heat insulating medium A, between the cover portion 242 and the first flow path 581 and between the cover portion 242 and the second flow path 582, and the first flow path 581 and the second flow path 582 are thermally insulated from each other by the first heat insulating space 661 and the second heat insulating space 662.

In accordance with such a configuration, the first flow path 581 through which the introduced (low-temperature) cooling medium F flows has the first heat insulating space 661, and the second flow path 582, through which the (high-temperature) cooling medium F that has been used for cooling flows, has the second heat insulating space 662. Accordingly, the heat of the cooling medium F in the second flow path 582 can be effectively suppressed from being transferred to the cooling medium F in the first flow path 581, by the heat insulating medium A in the first heat insulating space 661 and the second heat insulating space 662. Therefore, the cooling efficiency of the conversion unit 161 can be enhanced. Further, by providing the first flow path 581 and the second flow path 582 in the cover portion 242, the size of the rotating electric machine 14 in the radial direction can be reduced.

The rotating electric machine 14 is an outer rotor type rotating electric machine 14 in which at least a part of the rotor 22 is disposed radially outward of the stator 20. The plurality of conversion units 161 are disposed radially inward of the stator 20, and the plurality of capacitors 38 and the plurality of power modules 40 are disposed between the stator 20 and the cooling jackets 42.

In accordance with such a configuration, the electrical components 16 can be provided by using the space S radially inward of the stator 20. Therefore, the rotating electric machine system 10 can be reduced in size in the axial direction and the radial direction. By arranging the cooling jackets 42 away from the stator 20 having a large heat generation amount, the thermal influence of the stator 20 with respect to the cooling jackets 42 can be effectively suppressed.

The rotating electric machine 14 includes the first bus bar 361 that electrically connects the stator 20 and the electrical components 16, and the second bus bar 362 that electrically connects the DC power source 12 and the electrical components 16. The first bus bar 361 and the second bus bar 362 are arranged apart from each other in the axial direction of the rotating electric machine 14. The first bus bar 361 is provided at end one end part of the electrical components 16 in the axial direction, and the second bus bar 362 is provided at the other end part of the electrical components 16 in the axial direction.

In accordance with such a configuration, the rotating electric machine 14 can be reduced in size in the radial direction. Further, by arranging the first bus bar 361 and the second bus bar 362 with the electrical components 16 interposed therebetween, electricity can be efficiently conducted, and the rotating electric machine 14 having a good electrical and thermal balance can be realized.

In the rotating electric machine system 10, the plurality of power modules 40 and the plurality of capacitors 38 are each disposed such that the radially projected area is largest among the radially projected area (the first radially projected area, the second radially projected area), the axially projected area (the first axially projected area, the second axially projected area), and the circumferentially projected area (the first circumferentially projected area, the second circumferentially projected area).

In accordance with such a configuration, the plurality of capacitors 38 and the plurality of power modules 40 are each arranged to be placed vertically along the direction of the axis by arranging the capacitors 38 and the power modules 40 such that the radially projected area (the first radially projected area, the second radially projected area) is largest and the axial positions of the power modules 40 and the capacitors 38 are overlapped at least partially. This makes it possible to reduce the size of the rotating electric machine system 10 in the radial direction without increasing the size of the rotating electric machine system 10 in the axial direction.

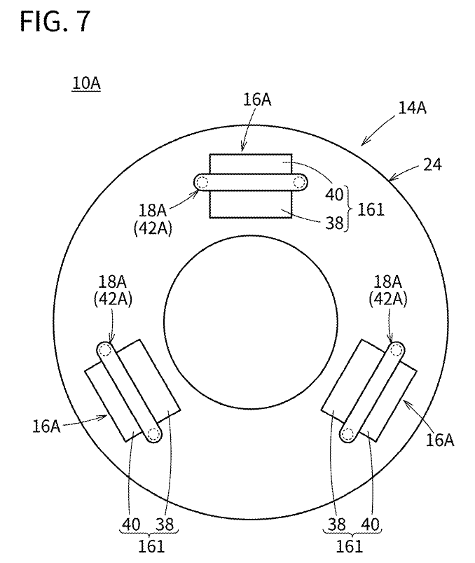

The electrical components 16 are not limited to the configuration in which the plurality of capacitors 38 and the plurality of power modules 40 are each arranged in the circumferential direction. For example, as shown in FIG. 7, in the rotating electric machine system 10A, the plurality of capacitors 38 and the plurality of power modules 40 constituting electrical components 16A are arranged in the radial direction. A cooling structure 18A (cooling jackets 42A) is disposed between each of the capacitors 38 and each of the power modules 40.

According to the rotating electric machine system 10A according to the modification, the electrical components 16A can be compactly disposed in the radial direction of a rotating electric machine 14A. In addition, in a plan view of the rotating electric machine 14A, in the case that the three-phase electrical components 16A can be disposed in one semicircular part of the case member 24, three-phase electrical components can be further disposed in the remaining semicircular part.

The rotating electric machine 14 is not limited to the outer rotor type. For example, the rotating electric machine system may be configured to include an inner rotor type rotating electric machine in which a rotor is disposed radially inward of a stator. In the inner rotor type rotating electric machine, a plurality of cooling jackets are disposed between a plurality of conversion units (capacitors and power modules) and a rotor. In this configuration, the cooling jackets can be disposed between the stator having a large heat generation amount and the conversion units having a small heat generation amount with respect to the stator, and thus, the thermal influence from the stator to the conversion unit is effectively suppressed.

With respect to the above disclosure, the following supplementary notes are disclosed.

### Supplementary Note 1

The rotating electric machine system (10) is equipped with the rotating electric machine (14) including the rotor (22) provided with the rotating shaft part, the rotating electric machine being configured to be driven by alternating current electrical power, and the electrical component (16) configured to convert the direct current electrical power into the alternating current electrical power, wherein the electrical component includes the plurality of capacitors (38) and the plurality of power modules (40), the power modules and the capacitors each include the principal surface (381, 401), and the side surface (382, 402) intersecting the principal surface and having the area smaller than the area of the principal surface, and wherein the capacitors and the power modules are arranged to surround the rotating shaft part in the manner so that the normal directions of the principal surfaces are directed along the radial direction of the rotating shaft part, and the capacitors and the power modules are arranged in the manner so that in the axial direction of the rotating shaft part, the axial position of each of the capacitors and the axial position of each of the power modules at least partially overlap each other.

In accordance with such a configuration, the entire rotating electric machine system 10 can be made compact. By suppressing an increase in the size of the rotating electric machine 14 in the axial direction, the axial strength can be effectively ensured. Further, even when the space S is provided inside the rotating electric machine system 10, an increase in the size of the rotating electric machine system 10 in the radial direction and the axial direction is effectively suppressed.

### Supplementary Note 2

In the rotating electric machine system according to Supplementary Note 1, the capacitors and the power modules may be arranged in the circumferential direction of the rotating electric machine. In accordance with such a configuration, it is possible to more effectively suppress an increase in the size of the rotating electric machine system 10 in the axial direction.

### Supplementary Note 3

In the rotating electric machine system according to Supplementary Note 1, the electrical component may include the plurality of conversion units (161) each including at least one of the capacitors and at least one of the power modules, the rotating electric machine system may further include the plurality of cooling jackets (42) configured to cool the plurality of conversion units, respectively, the plurality of cooling jackets may each include the jacket flow path (541, 542) through which the cooling medium (F) flows, and the plurality of cooling jackets may each have the thickness (T) along the normal direction of the principal surface and the length (L) along the axial direction of the rotor, the thickness being smaller than the length (L).

In accordance with such a configuration, in addition to the conversion units, the cooling jackets are disposed to be placed vertically along the axial direction, so that an increase in the size of the rotating electric machine system in the radial direction is effectively suppressed. The cooling efficiency can be enhanced by increasing the contact area between the cooling jacket and both the capacitor and the power module in the axial direction of the rotating electric machine.

### Supplementary Note 4

In the rotating electric machine system according to Supplementary Note 3, the plurality of cooling jackets may be provided for the multiple phases, respectively.

In accordance with such a configuration, since the plurality of cooling jackets are respectively provided for the multiple phases, the capacitors and the power modules can be cooled in the respective phases. Therefore, the conversion units for the respective phases can be uniformly cooled. In addition, it is possible to effectively suppress the cooling variation among the multiple phases.

### Supplementary Note 5

In the rotating electric machine system according to Supplementary Note 4, the plurality of cooling jackets may each include one of the capacitors, and one of the power modules, and wherein the jacket flow path includes the first flow portion (501) configured to cool the one of the capacitors, and the second flow portion (502) connected to the first flow portion on the downstream part of the first flow portion in the flow direction of the cooling medium, and configured to cool the one of the power modules.

In accordance with such a configuration, the cooling efficiency in the conversion unit can be effectively increased by first cooling the capacitor having a small heat generation amount with the cooling medium, and the cooling of the capacitor and the power module can be uniformly maintained. Further, the cooling degree of each of the plurality of cooling jackets can be kept uniform.

### Supplementary Note 6

In the rotating electric machine system according to Supplementary Note 5, the capacitors and the power modules may be alternately arranged along the circumferential direction of the rotating electric machine. In accordance with such a configuration, the amount of heat generation in the circumferential direction of the rotating electric machine can be made uniform.

### Supplementary Note 7

In the rotating electric machine system according to Supplementary Note 4, the plurality of cooling jackets may be spaced apart from each other in the circumferential direction of the rotating electric machine.

In accordance with such a configuration, by separating the cooling jackets from each other, it is possible to effectively suppress the thermal influence of the adjacent cooling jackets. The space between the plurality of cooling jackets can be effectively utilized.

### Supplementary Note 8

In the rotating electric machine system according to any one of Supplementary Notes 3 to 7, the rotating electric machine may include the stator (20), and the stator and the electrical component may be arranged in parallel with each other and spaced apart from each other in the radial direction.

In accordance with such a configuration, the stator and the electrical component are arranged in the radial direction, and thus the rotating electric machine system can be reduced in size in the axial direction. The heat generated in the stator can be effectively prevented from being transmitted to the electrical component.

### Supplementary Note 9

The rotating electric machine system according to Supplementary Note 8 may further include the case member (24) having the cylindrical shape and configured to retain the stator, wherein the case member may be provided between the stator and the electrical component, the case member may include the plurality of hole portions (34) penetrating the case member in the radial direction and spaced apart from each other in the circumferential direction of the rotating electric machine, and wherein the jacket flow path may include the upstream end portion and the downstream end portion in the flow direction of the cooling medium, the first connecting portion (561) provided at the upstream end portion, and the second connecting portion (562) formed at the downstream end portion and connected to one of the hole portions, and wherein the cooling medium flowing through each of the plurality of jacket flow paths may flow toward the stator through each of the hole portions.

In accordance with such a configuration, the cooling circuit of the electrical component and the cooling circuit of the stator are connected in series via the cooling jackets, and thus the cooling path of the electrical component and the cooling path of the stator can be effectively separated from each other. Therefore, a plurality of elements in the electrical component can be uniformly cooled, and the cooling efficiency can be further enhanced. Further, the stator is uniformly cooled in the circumferential direction by the plurality of hole portions, and thus cooling efficiency can be enhanced. Further, the cooling jackets and the stator retaining portion are connected to each other in the radial direction, so that the size in the radial direction can be reduced.

### Supplementary Note 10

In the rotating electric machine system according to Supplementary Note 9, the case member may include the cover portion (242) extending in the direction intersecting the axial direction of the rotating electric machine and facing the electrical component in the axial direction, the cover portion may include the first flow path (581) connected to the upstream end portion and through which the cooling medium flows, and the inlet portion (60) communicating with the first flow path and each of the jacket flow paths and into which the cooling medium is introduced from the outside.

In accordance with such a configuration, the cover portion for supplying the cooling medium from the outside to the cooling jacket does not overlap the electrical component in the radial direction. Therefore, the rotating electric machine system can be further reduced in size in the radial direction.

### Supplementary Note 11

In the rotating electric machine system according to Supplementary Note 10, the cover portion may be formed in the substantially disc shape, the cover portion may further include the second flow path (582) connected to the downstream part of each of the plurality of jacket flow paths, and the outlet portion (62) communicating with the second flow path and configured to lead out the cooling medium to the outside, and wherein the first flow path may include the heat insulating space (661) filled with the heat insulating medium (A) between the cover portion and the first flow path, and the second flow path may include the heat insulating space (662) filled with the heat insulating medium between the cover portion and the second flow path, and the first flow path and the second flow path may be thermally insulated from each other by the heat insulating spaces.

In accordance with such a configuration, the first flow path through which the introduced (low-temperature) cooling medium flows and the second flow path through which the (high-temperature) cooling medium that has been used for cooling flows, are separated from each other. Thus, it is possible to effectively suppress the heat of the cooling medium in the second flow path from being transferred to the cooling medium in the first flow path. Therefore, the cooling efficiency of the conversion unit can be enhanced. Further, by providing the first flow path and the second flow path in the cover portion, the size of the rotating electric machine in the radial direction can be reduced.

### Supplementary Note 12

In the rotating electric machine system according to Supplementary Note 8, the rotating electric machine may be the outer rotor type rotating electric machine in which at least a part of the rotor is disposed radially outward of the stator, the plurality of conversion units may be arranged radially inward of the stator, and the plurality of capacitors and the plurality of power modules may be arranged between the stator and the cooling jackets.

In accordance with such a configuration, since the electrical component can be provided by using a space radially inward of the stator, the rotating electric machine system can be reduced in size in the axial direction and the radial direction. By arranging the cooling jackets away from the stator having a large heat generation amount, the thermal influence of the stator with respect to the cooling jackets can be effectively suppressed.

### Supplementary Note 13

In the rotating electric machine system according to Supplementary Note 12, the rotating electric machine may include the first bus bar (361) configured to electrically connect the stator and the electrical component, and the second bus bar (362) configured to electrically connect the direct current power source (12) and the electrical component, wherein the first bus bar and the second bus bar may be disposed apart from each other in the axial direction of the rotating electric machine, and the first bus bar may be provided at one end part of the electrical component in the axial direction, and the second bus bar may be provided at the other end part of the electrical component in the axial direction.

In accordance with such a configuration, the rotating electric machine can be reduced in size in the radial direction. In addition, by arranging the first bus bar and the second bus bar with the electrical component interposed therebetween, electricity can be efficiently conducted, and the rotating electric machine having a good electrical and thermal balance can be realized.

### Supplementary Note 14

The rotating electric machine system is equipped with the rotating electric machine including the rotor provided with the rotating shaft part, the rotating electric machine being configured to be driven by alternating current electrical power, and the electrical component configured to convert direct current electrical power into the alternating current electrical power, wherein the electrical component includes the plurality of capacitors and the plurality of power modules, the plurality of power modules and the plurality of capacitors each have the radially projected area, the axially projected area, and the circumferentially projected area, and are each arranged in a manner so that the radially projected area is largest among the radially projected area, the axially projected area, and the circumferentially projected area, and the capacitors and the power modules are arranged so as to surround the rotating shaft part and are arranged in the manner so that in the axial direction of the rotating shaft part, the axial position of each of the capacitors and the axial position of each of the power modules at least partially overlap each other.

In accordance with such a configuration, the power modules and the capacitors are arranged to be placed vertically along the direction of the axis such that the radially projected area is largest among the radially projected area, the axially projected area, and the circumferentially projected area, and the axial positions of the capacitors and the axial positions of the power modules are overlapped at least partially. Thus, the rotating electric machine system can be reduced in size in the radial direction without increasing the size of the rotating electric machine system in the axial direction.

Although the present disclosure has been described in detail, the present disclosure is not necessarily limited to the specific embodiments described above. Within a range that does not depart from the essence and gist of the present disclosure, or within a range that does not depart from the purpose of the present disclosure derived from the content described in the claims and equivalents thereof, various additions, substitutions, changes, partial deletions, or the like can be made to such embodiments. These embodiments may also be implemented in combination. For example, in the embodiments described above, the order of the operations and the order of the processes are shown as examples, and the present invention is not limited to such operations and processes. The same applies to the case where numerical values or mathematical expressions are used in the description of the above-described embodiments.

1. A rotating electric machine system comprising:
a rotating electric machine including a rotor provided with a rotating shaft part, the rotating electric machine being configured to be driven by alternating current electrical power; and
an electrical component configured to convert direct current electrical power into the alternating current electrical power,
wherein the electrical component includes a plurality of capacitors and a plurality of power modules,
the power modules and the capacitors each include:
a principal surface; and
a side surface intersecting the principal surface and having an area smaller than an area of the principal surface, and
wherein the capacitors and the power modules are arranged to surround the rotating shaft part in a manner so that normal directions of the principal surfaces are directed along a radial direction of the rotating shaft part, and the capacitors and the power modules are arranged in a manner so that in an axial direction of the rotating shaft part, an axial position of each of the capacitors and an axial position of each of the power modules at least partially overlap each other.

2. The rotating electric machine system according to claim 1, wherein the capacitors and the power modules are arranged in a circumferential direction of the rotating electric machine.

3. The rotating electric machine system according to claim 1, wherein the electrical component includes a plurality of conversion units each including at least one of the capacitors and at least one of the power modules,
the rotating electric machine system further comprises a plurality of cooling jackets configured to cool the plurality of conversion units, respectively,
the plurality of cooling jackets each include a jacket flow path through which a cooling medium flows, and
the plurality of cooling jackets each have a thickness along the normal direction of the principal surface and a length along the axial direction of the rotor, the thickness being smaller than the length.

4. The rotating electric machine system according to claim 3, wherein the plurality of cooling jackets are provided for multiple phases, respectively.

5. The rotating electric machine system according to claim 4, wherein the plurality of cooling jackets each include:
one of the capacitors; and
one of the power modules, and
wherein the jacket flow path includes:
a first flow portion configured to cool the one of the capacitors; and
a second flow portion connected to the first flow portion on a downstream part of the first flow portion in a flow direction of the cooling medium, and configured to cool the one of the power modules.

6. The rotating electric machine system according to claim 5, wherein the capacitors and the power modules are alternately arranged along a circumferential direction of the rotating electric machine.

7. The rotating electric machine system according to claim 4, wherein the plurality of cooling jackets are spaced apart from each other in a circumferential direction of the rotating electric machine.

8. The rotating electric machine system according to claim 1, wherein the rotating electric machine includes a stator, and
the stator and the electrical component are arranged in parallel with each other and spaced apart from each other in the radial direction.

9. The rotating electric machine system according to claim 8, further comprising a case member having a cylindrical shape and configured to retain the stator,
wherein the case member is provided between the stator and the electrical component,
the case member includes a plurality of hole portions penetrating the case member in the radial direction and spaced apart from each other in a circumferential direction of the rotating electric machine,
wherein the jacket flow path includes:
an upstream end portion and a downstream end portion in a flow direction of the cooling medium;
a first connecting portion provided at the upstream end portion; and
a second connecting portion formed at the downstream end portion and connected to one of the hole portions, and
wherein the cooling medium flowing through each of the plurality of jacket flow paths flows toward the stator through each of the hole portions.

10. The rotating electric machine system according to claim 9, wherein the case member includes a cover portion extending in a direction intersecting the axial direction of the rotating electric machine and facing the electrical component in the axial direction,
the cover portion includes:
a first flow path connected to the upstream end portion and through which the cooling medium flows; and
an inlet portion communicating with the first flow path and each of the jacket flow paths and into which the cooling medium is introduced from outside.

11. The rotating electric machine system according to claim 10, wherein the cover portion is formed in a substantially disc shape, and
the cover portion further includes:
a second flow path connected to a downstream part of each of the plurality of jacket flow paths; and
an outlet portion communicating with the second flow path and configured to lead out the cooling medium to the outside, and
wherein the first flow path includes a heat insulating space filled with a heat insulating medium between the cover portion and the first flow path, and the second flow path includes a heat insulating space filled with a heat insulating medium between the cover portion and the second flow path, and
the first flow path and the second flow path are thermally insulated from each other by the heat insulating spaces.

12. The rotating electric machine system according to claim 8, wherein the rotating electric machine is an outer rotor type rotating electric machine in which at least a part of the rotor is disposed radially outward of the stator,
the plurality of conversion units are arranged radially inward of the stator, and
the plurality of capacitors and the plurality of power modules are arranged between the stator and the cooling jackets.

13. The rotating electric machine system according to claim 12, wherein the rotating electric machine includes:
a first bus bar configured to electrically connect the stator and the electrical component; and
a second bus bar configured to electrically connect a direct current power source and the electrical component,
wherein the first bus bar and the second bus bar are disposed apart from each other in the axial direction of the rotating electric machine, and
the first bus bar is provided at one end part of the electrical component in the axial direction, and the second bus bar is provided at another end part of the electrical component in the axial direction.

14. A rotating electric machine system comprising:
a rotating electric machine including a rotor provided with a rotating shaft part, the rotating electric machine being configured to be driven by alternating current electrical power; and
an electrical component configured to convert direct current electrical power into the alternating current electrical power,
wherein the electrical component includes a plurality of capacitors and a plurality of power modules,
the plurality of power modules and the plurality of capacitors each have a radially projected area, an axially projected area, and a circumferentially projected area, and are each arranged in a manner so that the radially projected area is largest among the radially projected area, the axially projected area, and the circumferentially projected area, and
the capacitors and the power modules are arranged so as to
surround the rotating shaft part and are arranged in a manner so that in an axial direction of the rotating shaft part, an axial position of each of the capacitors and an axial position of each of the power modules at least partially overlap each other.
